(19) United States
(12) Patent Application Publication
(10) Pub. No.: US 2012/0091707 A1
(43) Pub. Date: Apr. 19, 2012

(54) Anti-Expansion and Anti-Seismic Pipe Fitting

(76) Inventors: Do Youn Lee, Seoul (KR); Hyun Ung Song, Seoul (KR)

(21) Appl. No.: 13/271,847

(22) Filed: Oct. 12, 2011

(30) Foreign Application Priority Data
Oct. 15, 2010 (KR) 10-2010-0101013

(51) Int. Cl. F16L 19/00

(52) U.S. Cl. 285/348

(57) ABSTRACT

An anti-expansion and anti-seismic pipe fitting. The pipe fitting includes a body into which end portions of plural pipes are inserted. The body has a receiving jaw formed on the inner circumferential surface of an end portion, into which each of the pipe is inserted such that an inner diameter of the body is enlarged. A packing is arranged on the receiving jaw. A cap is coupled to the end portion of the body such that the packing and the pressurizing member are mounted inside the cap. Buffering means are included for absorbing expansion and contraction of the pipe. The pipe fitting can absorb deformation due to the expansion or contraction of the pipes. Moreover, because all of the pipes and the pipe fitting have the same inner diameter, the fluid flowing inside the pipes maintains uniform pressure, and hence, the fluid can flow smoothly inside the pipes.

### CROSS-REFERENCE TO RELATED APPLICATIONS

The present application claims priority to Korean Patent Application No. 10-2010-0101013, filed Oct. 15, 2010, the entirety of which is incorporated herein by reference.

### TECHNICAL FIELD

The present invention relates to an anti-expansion and anti-seismic pipe fitting, and more particularly, to an anti-expansion and anti-seismic pipe fitting, which can connect a number of pipes with one another in such a way as to seal them from the outside and can absorb deformation due to expansion and contraction caused by internal and external heat and other environment.

### BACKGROUND ART

In general, pipes are widely used as means for continuously conveying fluids such as liquids or gases over long distances.

Such pipes are generally made of plastics, metals or other materials according to kinds, ingredients and used environments of the fluids.

A number of the pipes are connected with one another from a place of supply to a place of consumption, and in this instance, pipe fittings are generally mounted at connection portions between the pipes.

Here, the pipes, in which liquids or gases with a big change in temperature flow, or, which are arranged at an area where temperature is changed largely, are expanded or contracted according to temperature of flowing materials or ambient temperature.

Moreover, the pipes are varied in length because they are minutely moved by a movement of the ground or the wall body in which the pipes are buried or by external force, such as wind.

As described above, in order to absorb the deformation of the pipes due to expansion or contraction, corrugated pipes are connected to pipelines or pipe fittings are connected to the pipes in such a fashion that the pipes can slide when the pipes are expanded or contracted.

FIG. 1 illustrates a conventional pipe fitting 10 according to a prior art, which does not absorb expansion and contraction of pipes. In FIG. 1, the conventional pipe fitting 10 includes a body 12 to which an end portion of a pipe 11 is inserted, a hollow-shaped cap 13 that is mounted at an end portion of the body 12, to which the end portion of the pipe 11 is inserted, a packing 14 interposed between the body 12 and the cap 13, an O-ring 15, and a pressurizing wedge 16.

The cap 13 is bolt-coupled to an end portion of the body 12 in such a way as to be firmly fastened in a state where the packing 14, the O-ring 15 and the pressurizing wedge 16 are disposed in the end portion of the body 12.

Thereby, the plural pipes 11 are connected to the pipe fitting in a state where they are sealed to each other.

However, such a, pipe fitting 10 cannot absorb a change such as expansion or contraction of the pipe 11 according to a change in temperature of a fluid flowing inside the pipe 11 or a change in ambient temperature.

In order to compensate the defect, pipe fittings for absorbing expansion and contraction of pipes have been developed, and FIG. 2 illustrates one of such pipe fittings. In FIG. 2, the pipe fitting 20 includes a pipe 21 having a stepped portion 21a and a front end portion with a smaller outer diameter, a ball-shaped pipe 22 mounted at the front end portion of the pipe 21, and a housing 23 mounted to surround the ball-shaped pipe 22.

In this instance, the pipe has an annular stopper 21b is fitted to a groove formed at a rear end portion of the pipe 21, and hence, a sliding range of the pipe 21 is a distance between the stepped portion 21a of the front end portion of the pipe 20 and the stopper 21b.

Here, the front end portion of the pipe 21 that belongs to the sliding range of the pipe 21 has inner and outer diameters reduced by the stepped portion 21a.

Moreover, the front end portion of the pipe 21, which has the reduced inner and outer diameters, is as long as an expected sliding distance of the pipe 21, namely, an expected expansion and contraction range of the pipe 21.

Accordingly, when the pipe 21 is expanded or contracted, the end portion of the pipe 21 slides along the ball-shaped pipe 22 to thereby absorb expansion and contraction of the pipe 21.

However, at the end portion of the pipe 21 having a predetermined length, pressure of the fluid flowing inside the pipe 21 rises as much as the reduced inner diameter because the inner and outer diameters of the pipe. 21 are reduced, and hence, it interferes the flow of the fluid and interrupts a smooth flow of the fluid.

Furthermore, if the stopper 21b, mounted to restrict the sliding range of the pipe 21 is destroyed by an excessive sliding of the pipe 21, the ball-shaped pipe 22 and the housing 23 are separated from the pipe 21, and hence, the pipe fitting 20 cannot serve its proper function.

Additionally, when the fluid is introduced into a space formed between the outer face of the pipe 21 and the curved portion of the inner face of the ball-shaped pipe 22, the fluid cannot move smoothly due to hydraulic pressure and an eddy phenomenon of the fluid caused when the fluid goes in and out.

In addition, the pipe fitting 20 also has an anti-seismic function, but has several problems in that: it is restricted in installation due to its expensive price and in that it is difficult to be manufactured due to its complicated structure.

### DISCLOSURE

### Technical Problem

Accordingly, the present invention has been mace in an effort to solve the above-mentioned problems occurring in the prior arts, and it is an object of the present invention to provide an anti-expansion and anti-seismic pipe fitting, which can absorb expansion and contract of a pipe, allow a smooth flow of a fluid because the pipe does not show any change, such as a reduction of the inner diameter of the pipe, and prevent a separation of the pipe due to destroy of a buffer even though the pipe slides excessively because the buffer is formed integrally to an end portion of the pipe.

Another object of the present invention is to provide an anti-expansion and anti-seismic pipe fitting, which has an excellent anti-seismic function because allowing the pipe connected to the pipe fitting to rotate on a longitudinal axis.

### Technical Solution

To achieve the above objects, the present invention provides an anti-expansion and anti-seismic pipe fitting, which is mounted at connection portions of pipes to connect a plurality of the pipes with one another, the pipe fitting including: a body into which an end portion of each of the pipes is inserted, the body having a receiving jaw formed on the inner circumferential surface of an end portion, into which the end portion of the pipe is inserted, in such a fashion that an inner diameter of the body is enlarged; a packing arranged on the receiving jaw; a cap coupled to the end portion of the body in such a way as to pressurize the packing; and buffering means for absorbing expansion and contraction of the pipe.

Here, the anti-expansion and anti-seismic pipe-fitting further includes a pressurizing member of a hollow pipe shape that is fit to the outer circumferential surface of the pipe and has a support jaw outwardly protruding at an end portion thereof opposed to the body.

In this instance, while being fitted to the outer circumferential surface of the pipe, the pressuring member is located inside the cap and an end portion of the pressuring member facing the body is arranged to pressurize the packing with a vertical plane of the receiving jaw relative to a longitudinal direction of the pipe.

Moreover, the cap is formed in a hollow pipe shape and includes: a protruding jaw that extends and inwardly protrudes from a portion joined to the body in order to pressurize the pressurizing member toward the packing while being joined to the outer circumferential surface of the end portion of the body, into which the pipe is inserted; and a stepped portion extending and inwardly protruding from the protruding jaw in the opposite direction of the body.

Furthermore, the buffering means includes a plurality of buffering projections protruding on the outer circumferential surface of the end portion of the pipe, which is inserted into the body, on the same plane at regular intervals.

Additionally, the buffering projections integrally protruding on the pipe are located within a range of a horizontal plane of the stepped portion relative to the longitudinal direction of the pipe and within a space having a height (H₁) of the vertical plane of the stepped portion, and side within a range of a length (L₁) from the stepped portion to the support jaw according to the expansion and contraction of the pipe.

Meanwhile, in another aspect of the present invention, the anti-expansion and anti-seismic pipe fitting according to another embodiment includes a cap of a hollow pipe shape having a stepped portion inwardly protruding on the inner circumferential surface of an end portion thereof opposed to the body.

The cap is joined to the inner circumferential surface of the body in such a fashion that the end portion of the cap facing the body pressurizes the packing with a vertical plane of the receiving jaw relative to the longitudinal direction of the pipe.

Moreover, the body has a partition wall inwardly protruding, on the inner circumferential surface of the body in such a way as to be interposed between the end portions of the pipes which are inserted into the body.

Furthermore, the anti-expansion and anti-seismic pipe fitting further includes a pressurizing ring of an annular shape interposed between the end portion of the cap pressurizing the packing and the packing.

Here, the buffering means includes a plurality of buffering projections protruding on the outer circumferential surface of the end portion of the pipe, which is inserted into the body, on the same plane.

Additionally, the buffering projections integrally protruding on the pipe are located within a range of a horizontal plane of the stepped portion relative to the longitudinal direction of the pipe and within a space having a height (H₁) of the vertical plane of the stepped portion, and side within a range of a length (L₁) from the stepped portion to the support jaw according to the expansion and contraction of the pipe.

### Advantageous Effects

As described above, according to the present invention, the anti-expansion and anti-seismic pipe fitting mounted at connection portions of the pipes can absorb the deformation due to the expansion or contraction of the pipes.

Moreover, because the end portion of the pipe connected with the pipe fitting is not changed in its inner diameter and all of the pipes have the same inner diameter, the fluid flowing inside the pipes maintains uniform pressure, and hence, the fluid can flow smoothly inside the pipes.

Furthermore, the buffering projections are formed integrally to the end portion of the pipe, and hence, it can prevent a separation of the pipes due to a destruction of the buffering projections, which may be caused by a sliding of the pipe owing to an excessive expansion or contraction if separate buffering projections are mounted on the pipe. Additionally, in the case that the pipe is inserted into the body according to the excessive expansion or contraction, the buffering projections can be additionally moved within a distance between the end portion of the body and the support jaw or within a resilient range of the packing by the media of the pressurizing member, and hence, it can prevent a destruction of the buffering projections.

In addition, the anti-expansion and anti-seismic pipe fitting according to the present invention does not have a space, to which the fluid may be introduced, between the pipe fitting and the connected pipes, and hence, it does not raise an eddy or a partial rise of hydraulic pressure, which may occur, when the fluid flows in and out the pipes, so that the pipe fitting is not destructed.

Moreover, in the case that the pipes are connected with one another via L-shaped or T-shaped pipe fittings, when earthquake occurs, the pipes rotate on an axis of the longitudinal direction at the connected portions to thereby provide an anti-seismic effect. As an example, the pipes arranged in a horizontal direction rotate on an axis of a horizontal central line, and the pipes arranged in a vertical direction pivotally rotate forward or backward. Accordingly, the anti-expansion and anti-seismic pipe fitting can absorb the expansion or contraction of the pipes due to heat or earthquake and cope with distortion of the ground due to earthquake to thereby provide an anti-seismic effect.

Furthermore, the pipe fitting is easy to be manufactured because it is simple in structure and reduces installation expenses because its manufacturing price is low.

### DESCRIPTION OF DRAWINGS

FIG. 1 is a schematically exploded perspective view of a pipe fitting according to a prior art.

FIG. 2 is a schematic side sectional view of a pipe fitting according to another prior art.

FIG. 3 is a schematic perspective view of an anti-expansion and anti-seismic pipe fitting according to a preferred embodiment of the present invention.

FIG. 4 is an exploded perspective view of the pipe fitting of FIG. 3.

FIG. 5a is a side sectional view of the pipe fitting of FIG. 3, and FIG. 5b is a view showing a used state of the pipe fitting of FIG.3.

FIGS. 6a and 6b are side sectional views showing a cap and a pressurizing member shown in FIG. 4.

FIG. 7 is a schematic perspective view of an anti-expansion and anti-seismic pipe fitting according to another preferred embodiment of the present invention.

FIG. 8 is an exploded perspective view of the pipe fitting of FIG. 7.

FIG. 9 is a side sectional view of the pipe fitting of FIG. 7.

FIG. 10 is a side sectional view showing a cap shown in FIG. B.

### MODE FOR INVENTION

Reference will be now made in detail to an anti-expansion and anti-seismic pipe fitting according to the preferred embodiments of the present invention with reference to the attached drawings.

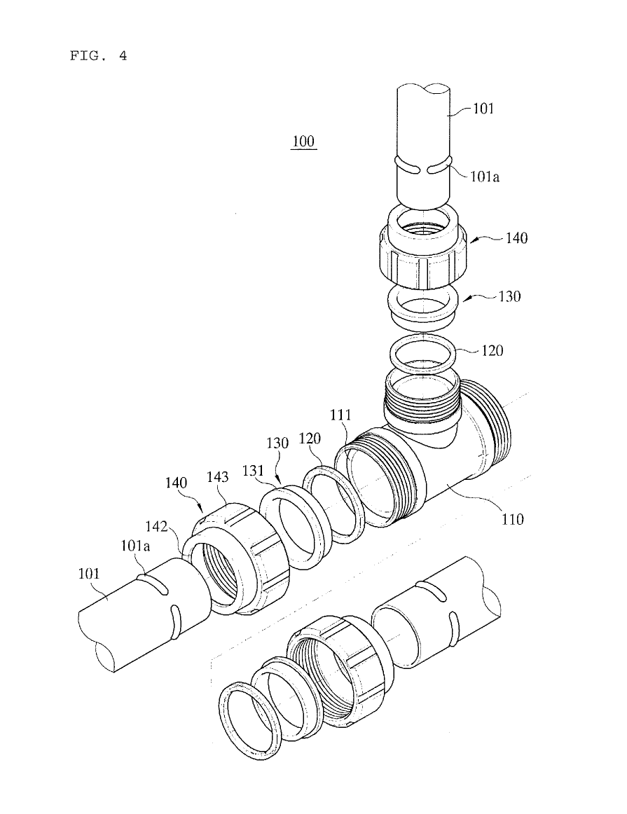

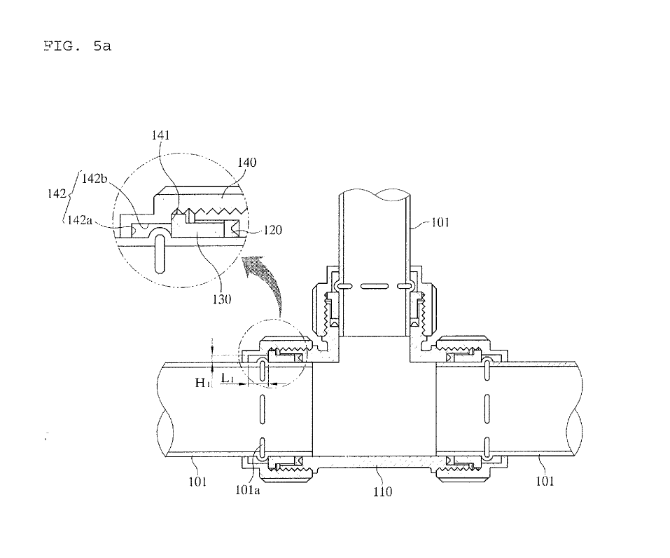

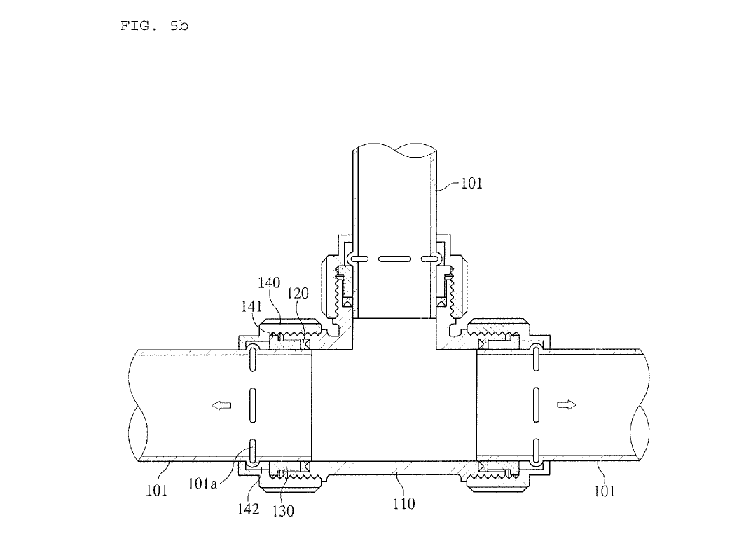

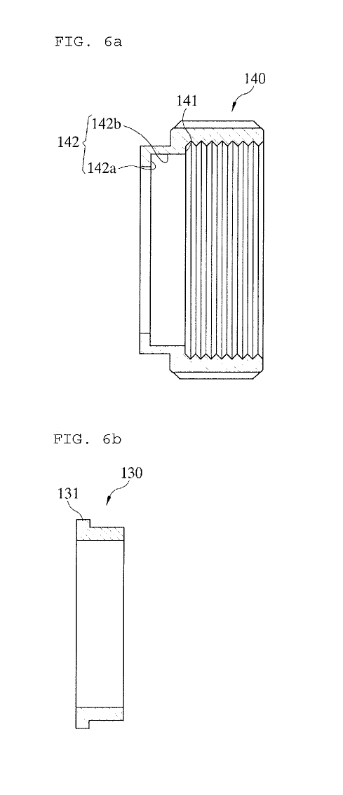

FIG. 3 is a schematic perspective view of an anti-expansion and anti-seismic pipe fitting according to a preferred embodiment of the present invention, FIG. 4 is an exploded perspective view of the pipe fitting of FIG. 3, FIG. 5a is a side sectional view of the pipe fitting of FIG. 3, FIG. 5b is a view showing a used state of the pipe-fitting of FIG, and FIGS. 6a and 6b are side sectional views showing a cap and a pressurizing member shown in FIG. 4.

First, as shown in FIGS. 3 and 4, the anti-expansion and anti-seismic pipe fitting 100 according to a preferred embodiment of the present invention includes: a body 110 to which end portions of a plurality of pipes 101 are inserted, the body 110 having a receiving jaw 111 formed on an inner circumferential surface of an end portion, in which each of the pipes 101 is inserted, in such a fashion that an inner diameter is enlarged; a packing 120 arranged on the receiving jaw 111; a pressurizing member 130 arranged on the packing 120 in such a fashion that the end portion is in contact with the packing 120; a cap 140 coupled to the end portion of the body 110, to which the pipe 101 is inserted, so that the packing 120 and the pressurizing member 130 are disposed inside the cap 140; and buffering means for absorbing expansion and contraction of the pipe 101.

Here, the pipes 101 are all of main pipes and branch pipes, the main pipes and branch pipes connected to the body 110 are just different from each other in their diameters and in changes of flow directions.

Accordingly, the main pipes and the branch pipes are all described as the pipes 101 because they are equal to each other in order and structure connected to the body 110 of the pipe fitting 100.

The body 110 is T-shaped in such a fashion that end portions of two main pipes and one branch pipe are connected to the T-shaped body 110.

The cap 140 is hollow and is bolt-coupled to an outer circumferential surface of the end portion of the body 110, in which the end portion of the pipe 101 is inserted.

Furthermore, as shown in FIGS. 4 to 6a, the cap 140 includes a protruding jaw 141 inwardly protruding on a portion which is coupled to the body 110 in order to pressurize the pressurizing member 130 toward the packing 120 while being coupled to the body 110.

Additionally, the cap 140 further includes a stepped portion 142 inwardly protruding and extending from the protruding jaw 141 in the opposite direction of the body 110.

In addition, the cap 140 includes a plurality of grip protrusions 143 formed on the outer circumferential surface of a portion of the cap, which is coupled to the body 110, at regular intervals so that a user can easily couple the cap 140 to the body 110 by rotating the cap 140.

As shown in FIGS. 4, 5a and 6b, the pressurizing member 130 is a hollow pipe and includes a support jaw 131 outwardly protruding on an end portion opposed to the body 110.

Moreover, the pressurizing member 130 is disposed in the cap 140 while being fitted on the outer circumferential surface of the pipe 101, so that the end portion of the body 110 pressurizes the packing 130 with the vertical plane of the receiving jaw 111 relative to a longitudinal direction of the pipe 101.

In this instance, one end portion of the pressurizing member 130 facing the body 110 is in contact with the packing 120, the outer face of the support jaw 131, which is the other end portion of the body 110, is in contact with the protruding jaw 141 of the cap 140, and the inner face of the support jaw 131 is spaced apart from one end surface of the body 110 at a predetermined interval. As shown in FIG. 5a, the interval between the inner face of the support jaw 131 and the end surface of the body 110 is to limit a destruction of a buffering projection 101a when the buffering projection 101a excessively slides toward the body 110. In more detail, when the buffering projection 101a slides and pressurizes the pressurizing member 130, the pressurizing member 130 is additionally moved within a range of the interval between the end surface of the body 110 and the support jaw 131 or within a resilient range of the packing 120.

As shown in FIGS. 5a and 5b, the buffering means includes a plurality of the buffering projections 101a formed on the outer circumferential surface of the end portion of the pope 101, which is inserted into the body 110, at regular intervals on the same level.

Here, it is preferable that the buffering projections 101a are formed integrally, and may be manufactured separately and fused to the pipe 101 by a bonding method, such as welding or fusion.

Furthermore, the buffering projections 101a may be made in a continued annular shape.

The buffering projections 101a are located within a range of a horizontal plane of the stepped portion 142 relative to the longitudinal direction of the pipe 101 and within a space having a height (H₁) of the vertical plane 142a of the stepped portion 142, and the sliding range of the buffering projections 101a according to the expansion and contraction of the pipe 101 is a length (L₁) ranging from the vertical plane 142a of the stepped portion 142 of the cap 140 to the support jaw 131 of the pressurizing member 130.

FIG. 5b illustrates a state where the buffering projection 101a slides from its initial position, wherein the sliding of the buffering projections 101a is, made by the buffering projections 101a moving by a change in length of the pipe 101 due to the expansion or contraction of the pipe 101. Alternatively, the sliding of the buffering projections 101a may be made by the pipe 101 moving by hydraulic pressure of the fluid or by a change of the ground.

Hereinafter, an anti-expansion and anti-seismic pipe fitting according to another preferred embodiment of the present invention will be described in detail with reference to the attached drawings.

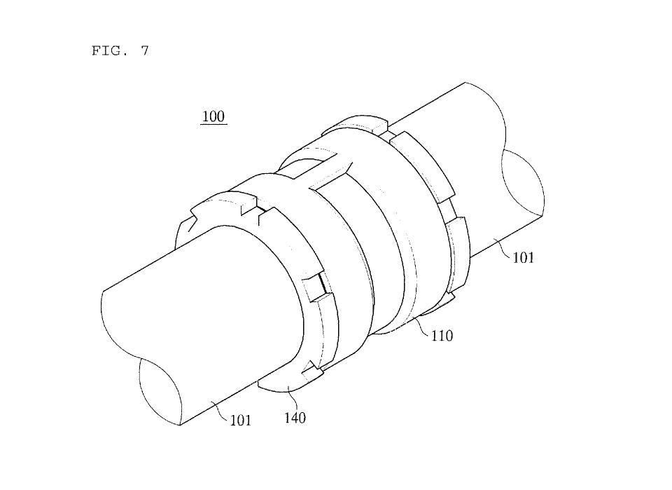

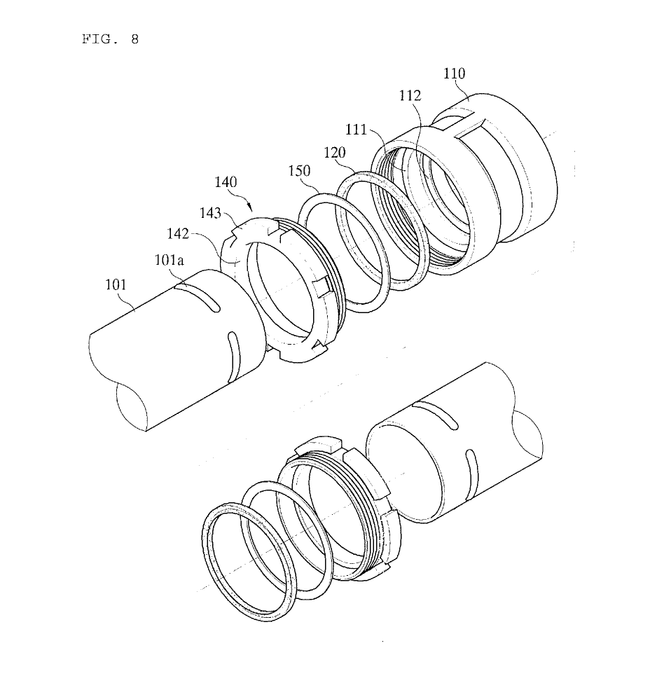

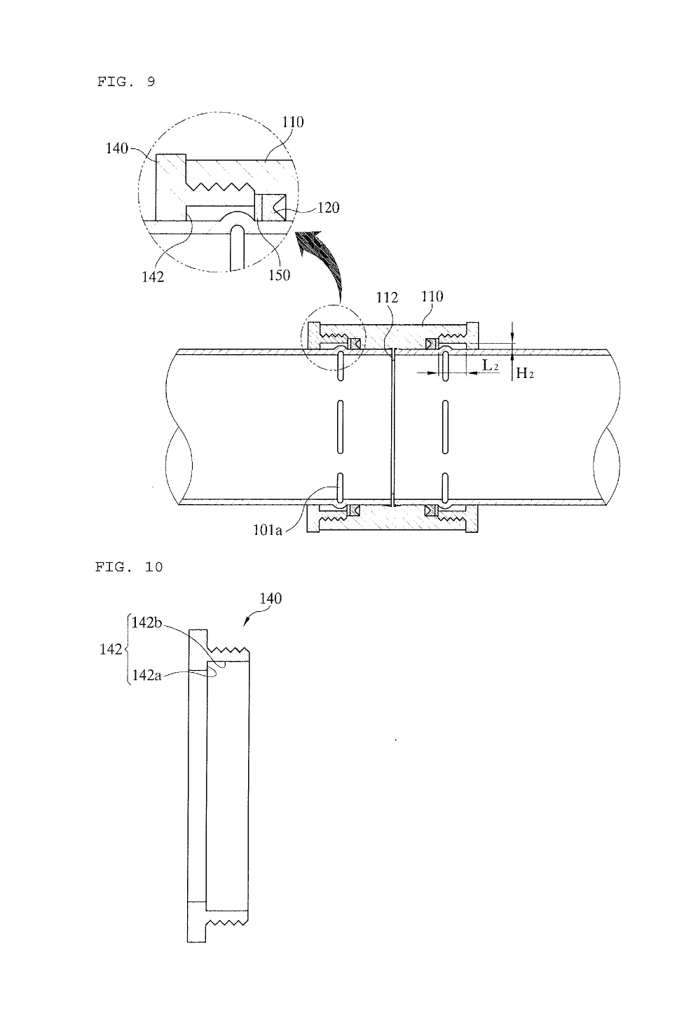

FIG. 7 is a schematic perspective view of an anti-expansion and anti-seismic pipe fitting according to another preferred embodiment of the present invention, FIG. 8 is an exploded perspective view of the pipe fitting of FIG. 7, FIG. 9 is a side sectional view of the pipe fitting of FIG. 7, and FIG. 10 is a side sectional view showing a cap shown in FIG. 8.

As shown in FIGS. 7 to 10, the anti-expansion and anti-seismic pipe fitting according to the second preferred embodiment of the present invention will be described, focusing on differences between the anti-expansion and anti-seismic pipe fitting of FIG. 3 and the anti-expansion and anti-seismic pipe fitting of FIG. 7 when they are compared with each other.

Here, in FIGS. 7 to 10, the components having the same reference numerals as the anti-expansion and anti-seismic pipe fitting of FIGS. 3 to 6b have the same functions as the anti-expansion and anti-seismic pipe fitting of FIGS. 3 to 6b.

In the second preferred embodiment illustrated in FIG. 7, two main pipes 101 are connected to the anti-expansion and anti-seismic pipe fitting 100, and the anti-expansion and anti-seismic pipe fitting according to the second preferred embodiment is different from the anti-expansion and anti-seismic pipe fitting according to the first preferred embodiment in shape of the body 110, exemption of the pressurizing member 130, shape of the cap 140, addition of a pressurizing ring 150, and buffering means.

In more detail, the body 110 is in the form of a straight line and includes: a receiving jaw 111 formed on the inner circumferential surface of an end portion, to which the pipe 101 is inserted, in such a fashion that the inner diameter is enlarged; and a partition wall 112 inwardly protruding on the inner face thereof in such a way as to be interposed between the inserted end portions of the pipes 101.

As shown in FIG. 9, the partition wall 112 restricts a length of the end portion of the pipe 101, which is inserted into the body 110, and prevents interference between the end portions of the pipes 101.

As shown in FIGS. 8 to 10, the cap 140 is in the form of a hollow pipe and includes a stepped portion 142 inwardly protruding on the inner circumferential surface of the other end portion of the body 110.

Moreover, a portion of the cap 140 facing the body 110 is coupled to the inner circumferential surface of the body 110 and the other portion is located outside the body 110. Additionally, the cap 140 includes a plurality of grip projections 143 formed on the outer circumferential surface of the other portion, which located outside the body 110, on the same plane at regular intervals.

Here, the cap 140 does not have the protruding jaw 141 of the first preferred embodiment illustrated in FIG. 3.

The grip projections 143 is a little different from the grip projections 143 of the first preferred embodiment illustrated in FIG. 3 in shape, but serve the same function as the grip projections 143 of the first preferred embodiment.

The pressurizing ring 150 of the second embodiment, which is not included in the pipe fitting of the first embodiment of FIG. 3, is in a hollow annular shape and is interposed between the end portion of the cap 140, which is coupled with the body 110, and the packing 120.

The buffering means includes a plurality of buffering projections 101a protrudingly formed on the outer circumferential surface of the end portion of the pipe 101, which is inserted into the body 110, on the same plane.

The buffering projections 101a are the same as the first embodiment of FIG. 3.

But, in the second embodiment, the buffering projections 101a are located within a range of a horizontal plane 142b of the stepped portion 142 relative to a longitudinal direction of the pipe 101 and within a space having a height (H₂) of a vertical plane 142a of the stepped portion 142. Furthermore, in the second embodiment, the sliding range of the buffering projections 101a according to the expansion and contraction of the pipe 101 is a length (L₂) ranging from the stepped portion 142 to the pressurizing ring 150.

Hereinafter, the coupling and action of the anti-expansion and anti-seismic pipe fitting according to the first preferred embodiment of FIG. 3 will be described.

First, after the packing 120 and the pressurizing member 130 are arranged at each end portion of the body 110, into which an end portion of each pipe 101 will be inserted, the cap 140 is bolt-coupled to the outer circumferential, surface of the body 110 in such a fashion that the end portion of the pipe 101 is inserted into the body 110 and the pressurizing member 130 is embedded in the cap 130.

In this instance, the packing 120 and the pressurizing member 130 are arranged on the receiving jaw 111 formed on the inner circumferential surface of the body 110 in order. When the cap 140 is mounted at the end portion of the body 110, the support jaw 131 of the pressurizing member 130 is pressurized toward the body 110 by the protruding jaw 141 of the cap 140.

Accordingly, by the pressuring member 130, the packing 120 is pressurized to the vertical plane of the receiving jaw 111 relative to the longitudinal direction of the pipe 101, and then, the packing 120 seals the inner circumferential surface of the body 110 from the outer circumferential surface of the pipe 101.

Moreover, the buffering projections 101a formed integrally with the pipe 101 by a transformation of some portion of the pipe 101 are located between the stepped portion 142 of the body 110 and the support jaw 131 of the pressurizing member 130.

Thereby, the pipes 101 can be firmly connected to the body 110 in a sealed condition.

Here, the buffering means absorbs the expansion and contraction of the pipe 101 while the buffering projections 101a slide within a range of the length (L₁) from the, support jaw 131 of the pressurizing member 130 to the vertical plane 142a of the stepped portion 142 of the cap 140 relative to the longitudinal direction of the pipe 101 according to the expansion and contraction of the pipe 101.

Hereinafter, the coupling order and action of the anti-expansion and anti-seismic pipe fitting according to the second preferred embodiment of FIG. 7 will be described.

First, after the packing 120 and the pressurizing ring 150 are arranged at each end portion of the body 110, into which an end portion of each pipe 101 will be inserted, the end portion of the pipe 101 is inserted into the body 110, and a portion of the cap 140 is bolt-coupled to the inner circumferential surface of the body 110.

In this instance, the packing 120 and the pressurizing ring 150 are arranged on the receiving jaw 111 formed on the inner circumferential surface of the body 110 in order. When the cap 140 is mounted at the end portion of the body 110, an end of the cap 140 coupled to the inner circumferential surface of the body 110 pressurizes the pressurizing ring 150.

Accordingly, by the pressuring ring 150, the packing 120 is pressurized to the vertical plane of the receiving jaw 111 of the cap 140 relative to the longitudinal direction of the pipe 101, and then, the packing 120 seals the inner circumferential surface of the body 110 from the outer circumferential surface of the pipe 101.

Here, the buffering projections 101a formed integrally to the pipe 101 are located between the pressuring ring 150 and the vertical plane 142a of the stepped portion 142 of the cap 140.

The partition wall 112 of the body 110 prevents interference between the end portions of the pipes 101, which are inserted into the body 110.

Thereby, the pipes 101 can be firmly connected to the body 110 in a sealed condition.

Moreover, the buffering means absorbs the expansion and contraction of the pipe 101 while the buffering projections 101a slide within a range of the length (L₂) from the pressurizing ring 150 to the vertical plane 142a of the stepped portion 142 of the cap 140 relative to the longitudinal direction of the pipe 101 according to the expansion and contraction of the pipe 101.

Here, the sliding of the buffering projection 101a is made by the buffering projections 101a moving by a change in length of the pipe 101 due to the expansion or contraction of the pipe 101 or by the pipe 101 moving by hydraulic pressure of the fluid or the ground environment.

The deformation of the pipes 101 due to the expansion and contraction is caused by heat of the fluid flowing inside the pipes 101 or by the external heat, and the expansion and contraction are absorbed by the anti-expansion and anti-seismic pipe fitting 100 according to the present invention.

Moreover, even though the pipes 101 get out of their initial position due to the hydraulic pressure of the fluid flowing inside the pipes 101 or due to a change in ground environment, such as ground settlement, earthquake, and others, the expansion and contraction of the pipes 101 can be absorbed by the anti-expansion and anti-seismic pipe fitting 100 according to the present invention.

In the pipe fitting 100, because the coupling between the pipes 101 and the body 110 and the coupling between the pipe 101 and the cap 140 are not completely fixed, even though the pipes 101 rotate on an axis of the central line of the longitudinal direction, the couplings between the pipes 101 and the body 110 and between the pipe 101 and the cap 140 can be maintained.

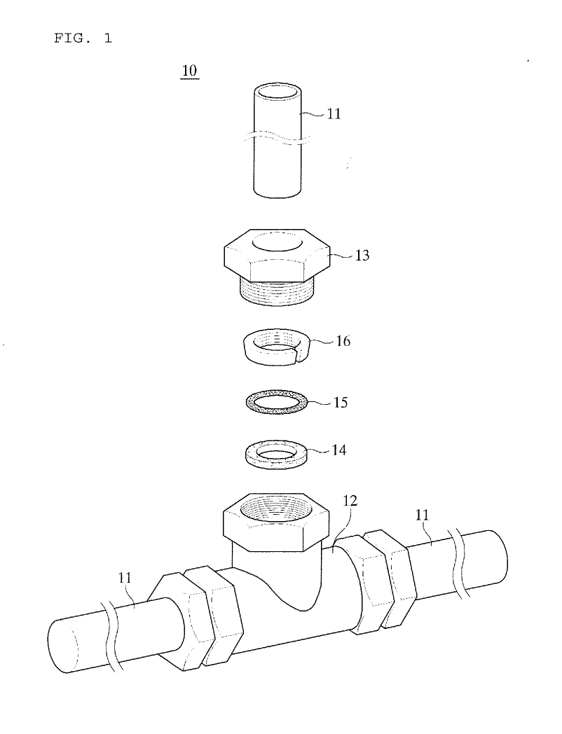

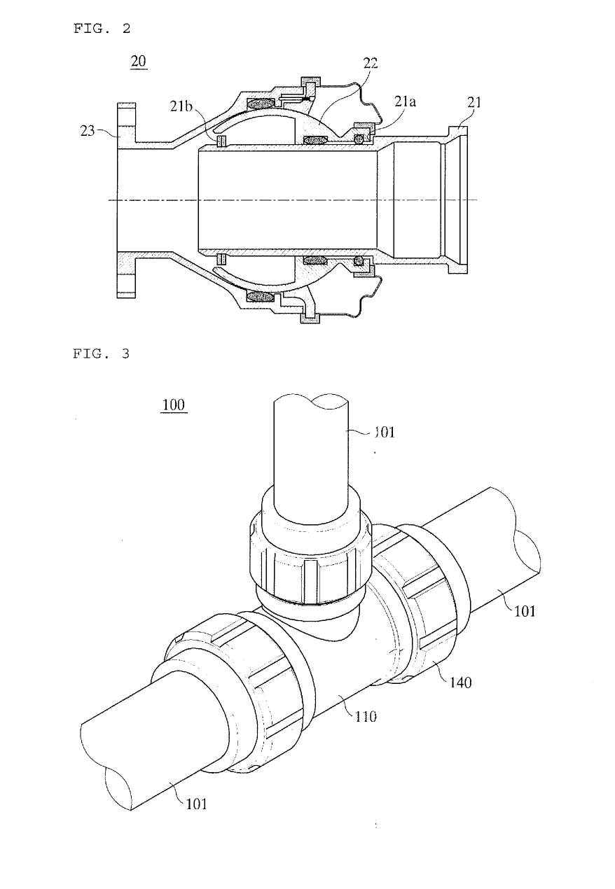

Accordingly, as shown in FIG. 1, in the case that the T-shaped pipe fitting 100 is arranged at the connection portions of the pipes 101, when earthquake occurs, the pipe 101 on a horizontal line rotates on the axis of the central line of the longitudinal direction, and the pipe 101 on a vertical line pivotally rotates forward or backward.

Thereby, the pipes 101 and the pipe fitting 110 are not destructed, and the pipe fitting 100 according to the present invention can carry out the anti-seismic function.

Here, an L-shaped pipe fitting 100 provides the anti-seismic function while rotating like the T-shaped pipe fitting 100, and a straight-shaped pipe fitting 100 supports the anti-seismic function by being connected with the L-shaped or T-shaped pipe fitting 100.

Additionally, when a plurality of the pipe fittings 100 are installed close together, it improves the anti-seismic function.

In the meantime, in order to describe the anti-expansion and anti-seismic pipe fitting 100 according to the present invention, FIG. 3 illustrates the pipe fitting to which three pipes are connected, and FIG. 7 illustrates the pipe fitting to which two pipes are connected. However, in the drawings, the number of the pipes connected to the pipe fitting are restricted for convenience sake, and two or more pipes can be connected to the pipe fitting according to the present invention.

In this instance, the body may be transformed corresponding to the number of the pipes, and the components of the pipe fitting according to the present invention are mounted at each end portion of the body, into which each of the pipes is inserted.

As described above, while the present invention has been particularly shown and described with reference to exemplary embodiments thereof, it will be understood by those of ordinary skill in the art that various changes in form and details may be made therein without departing from the spirit and scope of the present invention as defined by the following claims. It should be understood, however, that there is no intent to limit example embodiments of the invention to the particular forms disclosed, but on the contrary, example embodiments of the invention are to cover all modifications, equivalents, and alternatives falling within the scope of the invention.

### EXPLANATION OF ESSENTIAL REFERENCE NUMERALS IN DRAWINGS

| | | | |
|---|---|---|---|
| 100 | pipe fitting | 101 | pipe |
| 101a | buffering projection | 110 | body |
| 111 | receiving jaw | 120 | packing |
| 130 | pressurizing member | 131 | support jaw |
| 140 | cap | 141 | protruding jaw |
| 142 | stepped portion | | |

1. An anti-expansion and anti-seismic pipe fitting, which is mounted at connection portions of pipes to connect a plurality of the pipes with one another, the pipe fitting comprising:
a body into which an end portion of each of the pipes is inserted, the body having a receiving jaw formed on the inner circumferential surface of an end portion into which the end portion of the pipe is inserted in such a fashion that an inner diameter of the body is enlarged;
a packing arranged on the receiving jaw;
a cap coupled to the end portion of the body in such a way as to pressurize the packing;
a pressurizing member of a hollow pipe shape having a support jaw outwardly protruding at an end portion thereof opposed to the body, the pressurizing member being arranged in such a fashion that the end portion of the body pressurizes the packing with a vertical plane of the receiving jaw relative to a longitudinal direction of the pipe while the pressurizing member, is fit onto the outer circumferential surface of the pipe; and
buffering means adapted to absorb expansion and contraction of the pipe,
wherein the cap is formed in a hollow pipe shape and includes: a protruding jaw that extends and inwardly protrudes from a portion joined to the body in order to pressurize the pressurizing member toward the packing while being joined to the outer circumferential surface of the end portion of the body, into which the pipe is inserted; and
a stepped portion extending and inwardly protruding from the protruding jaw in the opposite direction of the body,
wherein the buffering means includes a plurality of buffering projections protruding on the outer circumferential surface of the end portion of the pipe, which is inserted into the body, on the same plane at regular intervals, and
wherein the buffering projections integrally protruding on the pipe are located within a range of a horizontal plane of the stepped portion relative to the longitudinal direction of the pipe and within a space having a height of the vertical plane of the stepped portion, and side within a range of a length from the stepped portion to the support jaw according to the expansion and contraction of the pipe.

2. An anti-expansion and anti-seismic pipe fitting, which-is mounted at connection portions of pipes to connect a plurality of the pipes with one another, the pipe fitting comprising:
a body into which an end portion of each of the pipes is inserted, the body including: a receiving jaw formed on the inner circumferential surface of an end portion into which the end portion of the pipe is inserted in such a fashion that an inner diameter of the body is enlarged; and a partition wall inwardly protruding on the inner circumferential surface in such a fashion as to be interposed between the end portions of the pipes which are inserted into the body;
a packing arranged on the receiving jaw;
a cap of a hollow pipe shape having a stepped portion inwardly protruding on the inner circumferential surface of an end portion, which is opposed to the body, the cap being joined to the inner circumferential surface of the end portion of the body in such a fashion that an end portion of the cap facing the body pressurizes the packing with a vertical plane of the receiving jaw relative to the longitudinal direction of the pipe;
a pressurizing ring of an annular shape interposed between the end portion of the cap pressurizing the packing and the packing; and
buffering means adapted to absorb expansion and contraction of the pipe,
wherein the buffering means includes a plurality of buffering projections protruding on the outer circumferential surface of the end portion of the pipe, which is inserted into the body, on the same plane at regular intervals, and
wherein the buffering projections integrally protruding on the pipe are located within a range of a horizontal plane of the stepped portion relative to the longitudinal direction of the pipe and within a space having a height of the vertical plane of the stepped portion, and side within a range of a length from the stepped portion to the support jaw according to the expansion and contraction of the pipe.
